(19) United States
(12) Patent Application Publication
(10) Pub. No.: US 2007/0115660 A1
(43) Pub. Date: May 24, 2007

(54) Backlight unit and liquid crystal display comprising the same

(75) Inventors: Seung-jae Lee, Suwon-si (KR); Dong-seob Jang, Seoul (KR); Seong-ho Youn, Hwaseong-si (KR); Chang-ju Kim, Suwon-si (KR); Sun-gil Kim, Suwon-si (KR); Hye-eun Park, Suwon-si (KR); Gi-su Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/593,604

(22) Filed: Nov. 7, 2006

(30) Foreign Application Priority Data
Nov. 19, 2005 (KR) 2005-0111041

(51) Int. Cl. F21V 11/00

(52) U.S. Cl. 362/240; 362/97; 362/561

(57) ABSTRACT

A backlight unit usable in an LCD includes a point light source circuit board, a plurality of point light sources seated on the point light source circuit board, and a diffusion lens provided on each point light source and comprising a depressed point and a curved surface radially protruding from the depressed point.

### CROSS-REFERENCE TO RELATED APPLICATIONS

This application claims priority under 35 U.S.C. §119 (a) Korean Patent Application No. 2005-0111041, filed on Nov. 19, 2005, in the Korean Intellectual Property Office, which is hereby incorporated in its entirety by reference.

### BACKGROUND OF THE INVENTION

1. Field of the Invention

The present general inventive concept relates to a backlight unit and a liquid crystal display comprising the same, and more particularly, to a backlight unit having a point light source and a liquid crystal display comprising the same.

2. Description of the Related Art

Recently, a flat panel display apparatus, such as a liquid crystal display (LCD), a plasma display panel (PDP), and an organic light emitting diode (OLED), has been developed to substitute for a conventional display such as a cathode ray tube (CRT).

The liquid crystal display (LCD) includes an LCD panel having a thin film transistor (TFT), a color filter substrate and a liquid crystal disposed therebetween. Since the LCD panel does not emit light by itself, the LCD includes a backlight unit at a rear side of the TFT substrate as a light source for providing light. The transmittance of the light generated from the backlight unit is adjusted according to an alignment of the liquid crystal. The LCD panel and the backlight unit are accommodated in a chassis of the flat panel display apparatus.

Depending on a location of the light source, the backlight unit may be classified as an edge type or direct type backlight unit. The edge type backlight unit is provided with the light source at a lateral side of a light guiding plate and is typically used for relatively small sized LCDs, such as those used in laptops and desktop computers. The edge type backlight unit provides high light uniformity and good endurance and is suitable for use in thin profile LCDs. However, its light efficiency is decreased because the emitted light is lost while getting through the light guiding plate. Also, the light guiding plate cannot be manufactured by using one mold in a case of a large sized LCD panel.

As the size of the LCD panel is increased, development of the direct type backlight unit has been emphasized. The direct type backlight unit provides light to the entire surface of the LCD panel by disposing a plurality of light sources a rear side of the LCD panel. The direct type backlight unit provides a high level of brightness by using a plurality of light sources, as compared with the edge type backlight unit, but the brightness is not sufficiently uniform due to a blur of color.

### SUMMARY OF THE INVENTION

The present invention provides a backlight unit having an improved color uniformity and a good light efficiency and a liquid crystal display comprising the same.

Additional aspects and advantages of the present general inventive concept will be set forth in part in the description which follows and, in part, will be obvious from the description, or may be learned by practice of the general inventive concept.

The foregoing to and/or other aspects of the present invention may be achieved by providing a backlight unit comprising a point light source circuit board, a plurality of point light sources seated on the point light source circuit board, and a diffusion lens provided on each point light source and comprising a depressed point and a curved surface radially protruding from the depressed point.

The curved surface may have a section shaped like a symmetrical non-circular curves.

The depressed point may be spaced apart from the point light sources by a predetermined distance.

The curved surface may be formed by the following equation, and A₁ is not equal to zero.

$$z ( r ) = \frac{c \cdot {r}^{2}}{1 + \sqrt{1 - ( 1 - k ) {c}^{2} {r}^{2}}} + {A}_{1} r + {A}_{2} {r}^{2} + {A}_{3} {r}^{3} + {A}_{4} {r}^{4} + {A}_{5} {r}^{5} + ⋯ + {A}_{n} {r}^{n}$$

where c=curvature of the diffusion lens, and k=Conic constant.

The diffusion lens may comprise a first lens surface adjacent to the point light sources and a second lens surface as the curved surface with the depressed point, the c may be a negative number, and the A₁ may be a positive number.

At least a portion of a section of the curved surface may be shaped like at least two or more different circular curves.

The backlight unit may further comprise a prominence and depression part formed on a surface of the diffusion lens.

The foregoing to and/or other aspects of the present invention may also be achieved by providing a liquid crystal display comprising a liquid crystal display panel, point light sources provided on an entire rear surface of the liquid crystal display panel, and a diffusion lens provided between the liquid crystal display panel and each point light source and comprising a depressed point and a curved surface radially protruding from the depressed point.

The curved surface may have a section shaped like a symmetrical non-circular curves.

The curved surface may be formed by the following equation, and A₁ is not equal to zero.

$$z ( r ) = \frac{c \cdot {r}^{2}}{1 + \sqrt{1 - ( 1 - k ) {c}^{2} {r}^{2}}} + {A}_{1} r + {A}_{2} {r}^{2} + {A}_{3} {r}^{3} + {A}_{4} {r}^{4} + {A}_{5} {r}^{5} + ⋯ + {A}_{n} {r}^{n}$$

where c=curvature of the diffusion lens, and k=Conic constant.

At least a portion of a section in the curved surface may be shaped like at least two or more different circular curves.

The liquid crystal display may further comprise a prominence and depression part formed on a surface of the diffusion lens.

The foregoing to and/or other aspects of the present invention may also be achieved by providing a backlight unit usable in a flat panel display, the backlight unit including a circuit board, a plurality of light sources disposed on the circuit board to generate light, and a diffusion lens having a first surface to receive the light from the corresponding light source, and having a second surface to emit the received light and having a depressed point having a depressed distance with the first surface and a surface extended from the depressed point and having a distance with the first distance, the distance varying from the depressed distance to a highest distance and a lowest distance according to a distance from the depressed point.

The distance may increase from the depressed distance to the highest distance and then decreases from the highest distance to the lowest distance according to the radius from a center of the diffusion lens. The light source may include an LED having a plastic mold disposed on the circuit board, a lead disposed in the plastic mold, and a chip disposed on the lead to be electrically connected to the light source through the lead to generate the light; and the first surface is disposed on the plastic mold and spaced apart from the chip.

The depressed point and the chip may be disposed on a line perpendicular to the circuit board, and the first surface of the diffusion lens may be extended from the plastic mold in a direction parallel to the circuit board. The first surface may include a first portion contacting a top surface of the plastic molding and a second portion extended from the first position in a direction perpendicular to a line connecting the chip and the depressed point, and an edge of the second portion may meet the second surface.

The light source may be disposed on a line perpendicular to the circuit board, and the depressed point is disposed on the line. The second surface may include a first spherical surface having a first radius and a second spherical surface having a second radius, the first spherical surface has the distance varying from the depressed distance to the highest distance, and the second spherical surface has the distance varying from the highest distance to the lowest distance.

The first surface may be a flat surface and the second surface is a curved surface, and the second surface may include a curved surface and a non-curved surface. The non-curved surface may include a flat surface formed in a circumferential direction of the depressed point.

The second surface may include a curved surface linearly varying with respect to a line passing though the depressed point, and may include a first portion having the distance which varies linearly and a second portion having the distance which varies non-linearly.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view illustrating an LCD according to an embodiment of the present general inventive concept;

FIGS. 2A and 2B are a sectional view and an exploded perspective view illustrating a diffusion lens of the LCD of FIG. 1, respectively;

FIG. 3 is a sectional view illustrating a diffusion lens according to an embodiment of the present general inventive concept;

FIG. 4 is a sectional view illustrating a diffusion lens according to an embodiment of the present general inventive concept; and

FIG. 5 is a view illustrating brightness of a diffusion lens according to the embodiment of the present general inventive concept and brightness of a conventional diffusion lens.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the drawings.

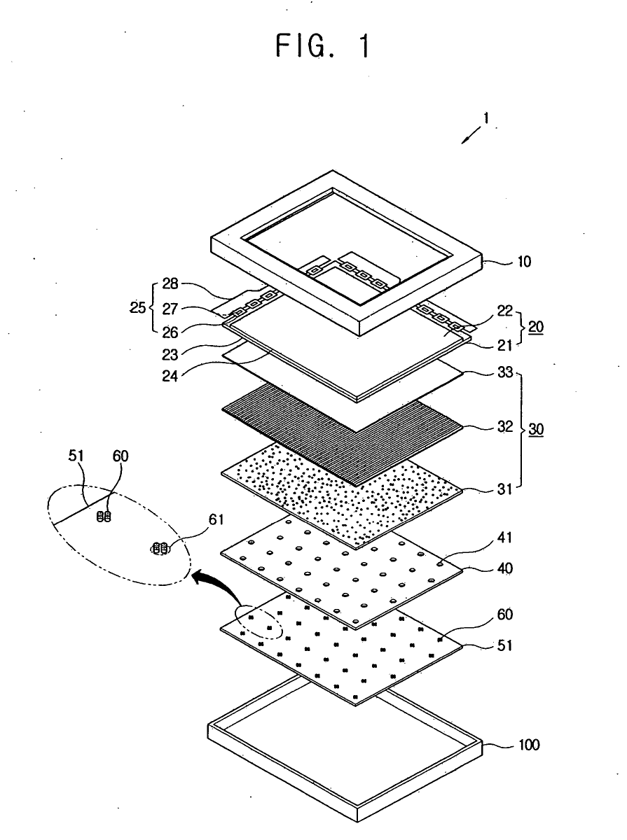

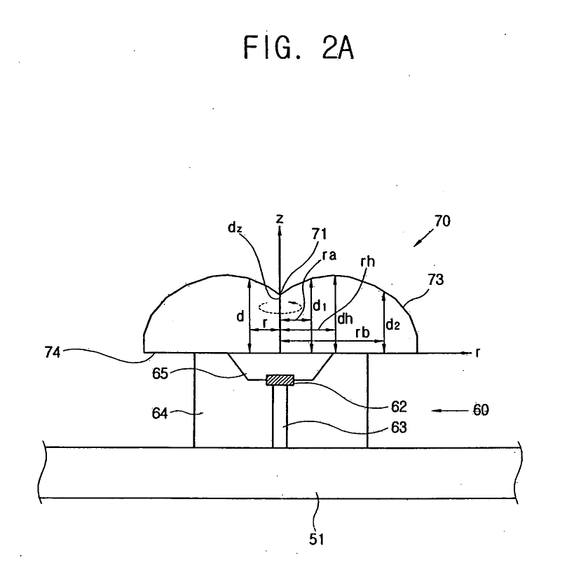

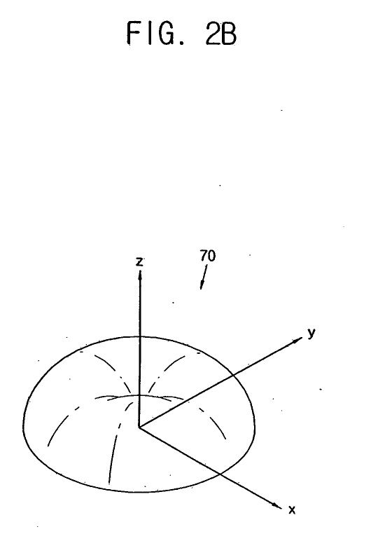

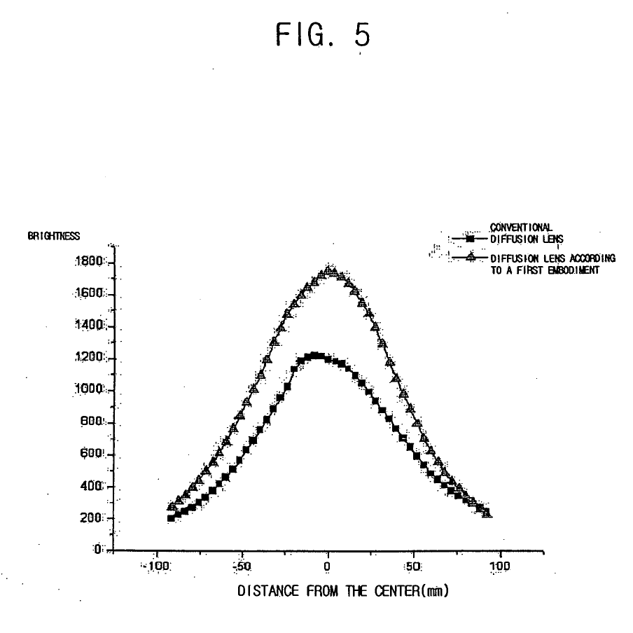

A liquid crystal display (LCD) according to an embodiment of the present general inventive concept will be described with reference to the FIGS. 1, 2A, 2B and 5. FIG. 1 is an exploded perspective view of an LCD 1 according to the embodiment of the present general inventive concept, FIGS. 2A and 2B are a sectional view and an exploded perspective view of the LCD of FIG. 1, and FIG. 5 is a view illustrating brightness of a diffusion lens according to the embodiment of the present general inventive concept and brightness of a conventional diffusion lens.

The LCD 1 comprises an LCD panel 20, a light regulating member 30, a reflecting plate 40, a light emitting diode (LED) circuit board 51 disposed in back of the LCD panel 20 in order; and an LED 60 seated on the LED circuit board 51 and disposed corresponding to an LED aperture 41 of the reflecting plate 40. A plurality of LEDs is disposed on the LED circuit boards 51 as the LED 60. The LED 60 may be used as an example of the LEDs.

The LCD panel 20, the light regulating member 30, and the LED circuit board 51 are accommodated between an upper chassis 10 and a lower chassis 100.

The LCD panel 20 comprises a TFT substrate 21 on which TFTs are formed, a color filter substrate 22 facing the TFT substrate 21, a sealant 23 attached to the two substrates 21 and 22 to form a cell gap, and a liquid crystal layer 24 surrounded by the two substrates 21 and 22 and the sealant 23 and disposed in the cell gap. The LCD panel 20 according to the present embodiment is provided as a rectangular shape having a long side and a short side.

The LCD panel 20 controls molecular alignment of liquid crystal of the liquid crystal layer 24, thereby forming an image thereon. However, the LCD panel 20 must be supplied with light from the LED 60 disposed at its rear, because the LCD panel 20 does not emit light by itself. On a side of the TFT substrate 21 is disposed a driving part 25 to apply driving signals to the LCD panel 20. The driving part 25 comprises a flexible printed circuit (FPC) 26 connected to the LCD panel 20, a driving chip 27 mounted on the FPC 26 to drive the LCD panel 20, and a printed circuit board (PCB) 28 connected on a side of the FPC 26 to control the driving chip 27. Here, the driving part 25 shown in FIG. 1 is a COF (chip on film) type. However, other types of driving parts may be used, such as TCP (tape carrier package) or COG (chip on glass) type. Alternatively, the driving part 25 may be formed on the TFT substrate 21 where wirings are formed.

The light regulating member 30 disposed at a rear side of the LCD panel 20 may comprise a diffusion plate 31, a prism film 32, and a protection film 33.

The diffusion plate 31 comprises a base plate and a coating layer having beads formed on the base plate. The diffusion plate 31 diffuses light from the LED 60, thereby improving a uniformity of the brightness.

Triangular prisms are placed on the prism film 32 in a predetermined arrangement. The prism film 32 concentrates the light diffused from the diffusion plate 31 in a direction perpendicular to a surface of the LCD panel 20. When two prism films 32 are used, the micro prisms formed on the prism film 32 form a predetermined angle each other. The light passing through the prism film 32 progresses vertically, thereby forming uniform brightness distribution. A reflective polarizing film may be used along with the prism film 32 as necessary, or only the reflective polarizing film may be used without the prism film 32.

The protection film 33, positioned at the top of the light regulating member 30, protects the prism film 32, which is vulnerable to scratching.

On the LED circuit board 51 on which the LEDs 60 are not seated is placed the reflecting plate 40. One or more LED apertures 41 are disposed in the reflecting plate 40 corresponding to the arrangement of LEDs 60. A plurality of sets of LED apertures 41 comprise one or more lines in parallel to each other, and each line includes a plurality of LED apertures 41 disposed at a regular interval. The LED apertures 41 between the adjacent lines are in staggered positions relative to each other. In each LED aperture 41 is disposed a white colored light providing unit 61 of the LED 60. The LED aperture 41 may be formed slightly larger than the white colored light providing unit 61.

Most part in addition to a chip 62 (FIG. 2A) generating light of the LED 60 is disposed over the reflecting plate 40. For example, when the white colored light providing unit 61 is disposed in the corresponding LED aperture 41, the most part and the chip 62 may protrude from the reflecting plate 40 such that the reflecting plate 40 reflects the light delivered downward and directs the reflected light to the diffusion plate 31. The reflecting plate 40 may be made of, e.g., polyethylene terephthalate (PET) or polycarbonate (PC), and/or be coated with silver (Ag) or aluminum (Al). In addition, the reflecting plate 40 may be formed with a sufficient thickness so as to prevent distortion or shrinkage due to heat generated from the LED 60.

Because the LED 60 may generate a significant amount of heat, the LED circuit board 51 may be primarily made of aluminum (Al) having an excellent thermal conductivity. Although not shown in drawings, the LCD 1 may further comprise a heat pipe, a heat radiating fin, a cooling fan, or other cooling mechanisms for removing the heat generated by the LED 60.

The LEDs 60, seated on the LED circuit board 51, are disposed across the entire rear surface of the LCD panel 20. A predetermined number of LEDs 60 are included in each of the plurality of white colored light providing units 61 to provide white colored light. The predetermined number of the LEDs 60 may be disposed in the corresponding LED aperture 41. In the present embodiment, the white colored light providing unit 61 comprises a red LED, a blue LED and a pair of green LEDs which respectively generate red, blue and green lights to be combined into the white color light. The white colored light providing units 61 are disposed on the LED circuit board 51 at a regular interval.

Referring to FIG. 2A, the LED 60 comprises the chip 62 to generate light, a lead 63 to connect the chip 62 with the LED circuit board 51, a plastic mold 64 to accommodate the lead 63 and surrounding the chip 62, a filling material 65 comprising silicon and disposed on an upper part of the chip 62, and a diffusion lens 70. A pattern of the light generated from the LED 60 is mainly influenced by a shape of the diffusion lens 70. The diffusion lens 70 according to the present embodiment will be described in detail hereinafter.

FIG. 2A is a sectional view of the LED 60 and FIG. 2B is a perspective view illustrating the diffusion lens 70 in three-dimensional. As illustrated in FIGS. 2A and 2B, the diffusion lens 70 according to the present embodiment comprises a surface 73 radially protruding with respect to a depressed point 71 having a shape similar to an upper shape of an apple. The surface 73 may be a curved surface having the depressed point 71 at its center. The depressed point 71 and the chip 62 are spaced apart from each other by a predetermined distance.

The depressed point 71 may be disposed on a line corresponding to a z axis of FIG. 2A. The diffusion lens 70 may include a bottom surface 74 disposed on top surfaces of the plastic mold 60 and/or the filing material 65, and a distance d between the surface 73 and the bottom surface 74 in a direction parallel to a z axis of FIG. 2A may vary according to a radius r from the z axis and/or the depressed point 71. The distance d (d1) may increase within a first radius ra to a highest distance dh, and the distance d (d2) may become decrease according to a second radius rb longer than the first radius ra. A distance dz (the predetermined distance) between the depressed point 71 and the bottom surface 74 is less than the highest distance dh.

The diffusion lens 70 may be made of polymethylmetharcylate (PMMA) or polycarbonate (PC). It is preferred that the filling material 65 contacted with the diffusion lens 70 on an upper part of the chip 62 may have a refractive index similar to that of the diffusion lens 70. It is preferred that a ratio of the refractive index in the filling material 65 to that of the diffusion lens 70 is between 0.8 and 1.2. Also, it is preferred that bonding material such as epoxy connecting the diffusion lens 70 with the chip 62 has the refractive index similar to that of the diffusion lens 70.

The curved surface 73 as an aspheric surface made of the diffusion lens 70 is a shape in which a non-circular curved line rotates with respect to a z-axis at an angle of 360 degrees as shown in the sectional view. In other words, a pair of the non-circular curved lines symmetrically shapes along a section of the curved surface 73. An aspheric surface equation made of the curved surface 73 is the same as the following mathematical equation 1 and A₁ is not equal to zero.

[Mathematical Equation 1]

$$z ( r ) = \frac{c \cdot {r}^{2}}{1 + \sqrt{1 - ( 1 - k ) {c}^{2} {r}^{2}}} + {A}_{1} r + {A}_{2} {r}^{2} + {A}_{3} {r}^{3} + {A}_{4} {r}^{4} + {A}_{5} {r}^{5} + ⋯ + {A}_{n} {r}^{n}$$

where r=x²+y², c=curvature of the diffusion lens, and k=Conic constant.

The variable r corresponds to an x-y planar distance from a center illustrated in FIG. 2B in three-dimensional. Accordingly, the mathematical equation 1 is an equation of the non-circular curved line in FIG. 2A.

In case of a general lens, the aspheric surface equation does not comprise an odd order term such as a first term coefficient A₁ because the aspheric surface of the lens is asymmetry with respect to the z-axis, when the aspheric surface equation comprises the odd order term. However, in the diffusion lens 70 of the present embodiment, r may be positive numbers in the aspheric surface equation. Also, the non-circular curved line rotates with respect to the z-axis and then the diffusion lens 70 is formed. Because the aspheric surface is formed, the diffusion lens 70 may have a rotationally symmetric shape. The diffusion lens 70 may be formed in various modifications using a coefficient of the odd order term as well as that of an even order term to form the aspheric surface. Also, when the diffusion lens 70 is formed, degree of freedom in a design is increased due to various combinations of the coefficients. The Conic constant and the curvature of the diffusion lens 70 are regulated in various values.

It is possible that c is a negative number and a first term coefficient A₁ is a positive number opposite to a value of c to form a spherical surface protruding to a direction of the z-axis from the x-y plane.

If the aspheric surface equation comprises the first term coefficient A₁ among odd order terms, a discontinuous portion like the depressed point 71 according to the present embodiment is formed. Because a concave shape toward a direction of the chip 62 like the ingression point 71 disperses light which is concentratedly radiated to a very upper portion of the chip 62, with a large light emitting angle, a hot spot is decreased and thereby a uniformity of light brightness distribution and a color uniformity are increased.

The aspheric surface according to the present embodiment may comprise a plane surface not a curved surface. On the other words, two or more different curved surfaces may be formed as the surface 73, and the aspheric surface may comprise a two-dimensional plane surface. In this case, the curve of the section in the diffusion lens 70 partially comprises a straight line.

FIG. 5 is a graph illustrating an improved brightness of the diffusion lens 70 according to the present embodiment and brightness of a conventional diffusion lens. The white colored light providing unit 61 used in the present embodiment comprises the red LED, the blue LED and a pair of the green LEDs. The diffusion lens 70 in which the depressed point 71 is formed thereon is used so that a range in which light emitted therefrom is extended, that is, light is dispersed into more broaden area. Accordingly, the brightness of the diffusion lens 70 is higher than the conventional brightness of the conventional diffusion lens when the diffusion lens 70 which is in a position separated at a predetermined distance from a center in which an LED 60 is disposed as well as in the center in which the LED 60 is disposed. A fine shape adjustment of a lens surface using a polynomial expression in the aspheric surface equation expressing the curved surface controls the light emitting angle of the lens in effective. Also, after emitted from the lens surface, light toward a bottom is decreased and light toward the LCD panel 20 is increased. Accordingly, the brightness of the center is increased about 40% as compared with the conventional brightness and power consumption is decreased according to the increasing brightness.

Also, a prominence and depression part may be formed on the surface of the diffusion lens 70 according to another embodiment of the present invention. A surface roughness of the diffusion lens 70 is enhanced by the prominence and depression part and a diffusion of light is induced. Accordingly, the brightness uniformity and the color uniformity of the light provided with the LCD panel 20 is enhanced. Size and shape of the prominence and depression part is not limited and may be formed by scratching the surface in the diffusion lens 70, for example.

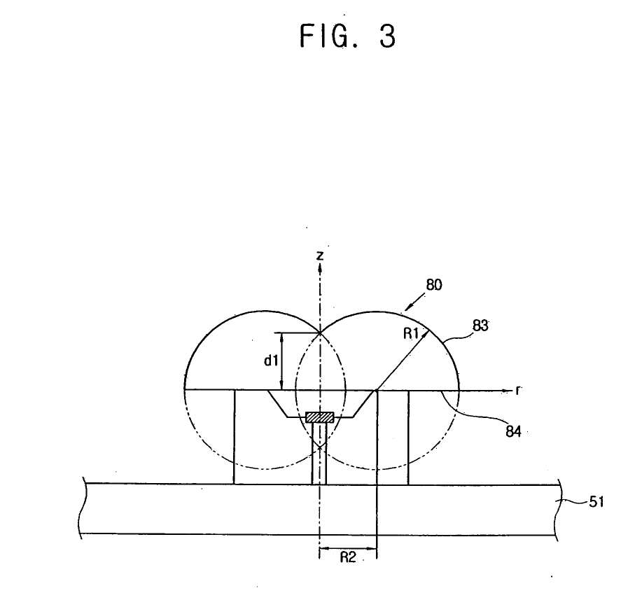

FIG. 3 is a view illustrating a diffusion lens 80 according to an embodiment of the present general inventive concept. Referring to FIG. 3, a section of the diffusion lens 80 has a shape in which a pair of circular curved lines are symmetrically connected to form a surface 83. The diffusion lens 80 according to the present embodiment is constituted of a spherical surface in which a portion of a semicircle is rotated with respect to the z-axis different from the embodiment illustrated in FIG. 2B.

A radius of a circle is R1 and a distance from the z-axis to a center of the circle is R2. Here, it is possible that R2 is shorter than R1. If R2 is the same as R1, a function of the diffusion may be remarkably decreased because the diffusion lens 80 becomes a hemisphere type. Also, if R2 is longer than R1, a hollow space is formed on the center of the diffusion lens 80 and light emitted from the chip 62 does not pass the diffusion lens 80.

If a distance in which the depressed point is spaced from a bottom surface 84 of the diffusion lens 80 is d1, the distance d1 is equal to (R1²−R2²)^{1/2} because the center of the circle is located on an r-axis in the present embodiment. If a z-axis coordinate of the center in the circle is a positive number, that is, the distance d1 is longer than (R1²−R2²)^{1/2}, a process for producing the diffusion lens 80 may be troublesome. More particularly, an injection of the diffusion lens 80 is difficult in a molding process because the center of the diffusion lens 80 is depressed downwardly. Accordingly, if the distance d1 is longer than (R1²−R2²)^{1/2}, it is possible that an edge of the diffusion lens 80 is formed as a straight line.

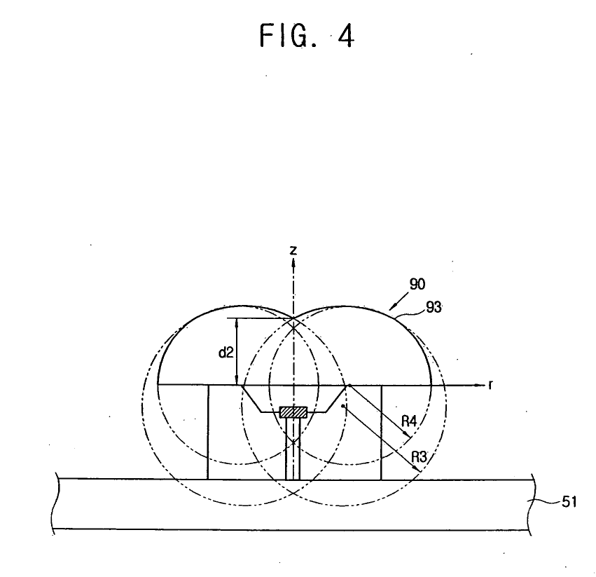

FIG. 4 is a view illustrating a diffusion lens 90 according to an embodiment of the present general inventive concept. Referring to FIG. 4, a section of the diffusion lens 90 has a shape in which a pair of circular curved lines are symmetrically connected. A curved surface 93 of the diffusion lens 90 according to the present embodiment is constituted of a shape in which two different circles are composed.

A radius of an inner circle is R4 and a radius of an outer circle is R3, and R3 is longer than R4. Alternatively, each radius of the two circles and the relative relation of their lengths are is not limitable. However, each slope of tangent lines has the same value in a node in which the two circles are united so that the two circles are smoothly connected without an infection.

Also, if a z-axis coordinate of begins with a positive number, it is possible that an edge of the diffusion lens 90 is formed as a straight line.

Light generated from the LED 60 may have higher uniformity through the diffusion lenses 70, 80 and 90 to provide it to the LCD panel 20. The shapes of the diffusion lenses 70, 80 and 90 are not limited the aforementioned embodiments and may have various modifications.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A backlight unit comprising:
a point light source circuit board;
a plurality of point light sources seated on the point light source circuit board; and
a diffusion lens provided on each point light source, and comprising a depressed point and a surface radially protruding from the depressed point.

2. The backlight unit according to claim 1, wherein the surface comprises a section having a shape of one or more symmetrical non-circular curves.

3. The backlight unit according to claim 1, wherein the depressed point is spaced apart from the point light source by a predetermined distance.

4. The backlight unit according to claim 2, wherein the surface is formed by the following equation:
$$z ( r ) = \frac{c \cdot {r}^{2}}{1 + \sqrt{1 - ( 1 - k ) {c}^{2} {r}^{2}}} + {A}_{1} r + {A}_{2} {r}^{2} + {A}_{3} {r}^{3} + {A}_{4} {r}^{4} + {A}_{5} {r}^{5} + ⋯ + {A}_{n} {r}^{n}$$
where A₁ is not equal to zero, c is a curvature of the diffusion lens, and k is a Conic constant.

5. The backlight unit according to claim 4, wherein the surface of the diffusion lens comprises a first lens surface adjacent to the point light source and a second lens surface as the curved surface with the depressed point, when c is a negative number and A₁ is a positive number.

6. The backlight unit according to claim 1, wherein the surface is formed by the following equation:
$$z ( r ) = \frac{c \cdot {r}^{2}}{1 + \sqrt{1 - ( 1 - k ) {c}^{2} {r}^{2}}} + {A}_{1} r + {A}_{2} {r}^{2} + {A}_{3} {r}^{3} + {A}_{4} {r}^{4} + {A}_{5} {r}^{5} + ⋯ + {A}_{n} {r}^{n}$$
where A₁ is not equal to zero, c=curvature of the diffusion lens, and k=Conic constant.

7. The backlight unit according to claim 6, wherein the surface of the diffusion lens comprises a first lens surface adjacent to the point light source and a second lens surface as the surface with the depressed point, when c is a negative number and A₁ is a positive number.

8. The backlight unit according to claim 1, wherein the surface comprises a section having a shape of one or more symmetrical circular curves.

9. The backlight unit according to claim 1, wherein the surface comprises a curved surface having a section of which at least portion has a shape of at least two or more different circular curves.

10. The backlight unit according to claim 1, further comprising:
a prominence and depression part formed on the surface of the diffusion lens.

11. The liquid crystal display comprising:
a liquid crystal display panel;
point light sources provided on an entire rear surface of the liquid crystal display panel; and
a diffusion lens provided between the liquid crystal display panel and each point light source, and comprising a depressed point and a surface radially protruding from the depressed point.

12. The liquid crystal display according to claim 11, wherein the surface comprises a section having a shape of one or more symmetrical non-circular curves.

13. The liquid crystal display according to claim 12, wherein the curved surface is formed by the following equation:
$$z ( r ) = \frac{c \cdot {r}^{2}}{1 + \sqrt{1 - ( 1 - k ) {c}^{2} {r}^{2}}} + {A}_{1} r + {A}_{2} {r}^{2} + {A}_{3} {r}^{3} + {A}_{4} {r}^{4} + {A}_{5} {r}^{5} + ⋯ + {A}_{n} {r}^{n}$$
where A₁ is not equal to zero, c=a curvature of the diffusion lens, and k=a Conic constant.

14. The liquid crystal display according to claim 11, wherein the surface is formed by the following equation:
$$z ( r ) = \frac{c \cdot {r}^{2}}{1 + \sqrt{1 - ( 1 - k ) {c}^{2} {r}^{2}}} + {A}_{1} r + {A}_{2} {r}^{2} + {A}_{3} {r}^{3} + {A}_{4} {r}^{4} + {A}_{5} {r}^{5} + ⋯ + {A}_{n} {r}^{n}$$
where A₁ is not equal to zero, c=a curvature of the diffusion lens, and k=a Conic constant.

15. The liquid crystal display according to claim 11, wherein the surface comprises a section having a shape of one or more symmetrical circular curves.

16. The liquid crystal display according to claim 11, wherein the surface comprises a curved section of which at least a portion has a shape of at least two or more different circular curves.

17. The liquid crystal display according to claim 11, further comprising:
a prominence and depression part formed on the surface of the diffusion lens.

18. A backlight unit usable in a flat panel display, comprising:
a circuit board;
a plurality of light sources disposed on the circuit board to generate light; and
a diffusion lens having a first surface to receive the light from the corresponding light source, and having a second surface to emit the received light and having a depressed point having a depressed distance with the first surface and a surface extended from the depressed point and having a distance with the first distance, the distance varying from the depressed distance to a highest distance and a lowest distance according to a distance from the depressed point.

19. The backlight unit according to claim 18, wherein the distance increases from the depressed distance to the highest distance and then decreases from the highest distance to the lowest distance according to the radius from a center of the diffusion lens.

20. The back light unit according to claim 18, wherein the second surface comprises a first spherical surface having a first radius and a second spherical surface having a second radius.

21. The back light unit according to claim 20, wherein the first spherical surface has the distance varying from the depressed distance to the highest distance, and the second spherical surface has the distance varying from the highest distance to the lowest distance.

22. The back light unit according to claim 18, wherein the second surface comprises a curved surface and a non-curved surface.

23. The back light unit according to claim 22, wherein the non-curved surface comprises a flat surface formed in a circumferential direction of the depressed point.

24. The back light unit according to claim 18, wherein the second surface comprises a curved surface linearly varying with respect to a line passing though the depressed point.

25. The back light unit according to claim 18, wherein the second surface comprises a first portion having the distance varying linearly and a second portion having the distance non-linearly varying.
